(19) United States
(12) Patent Application Publication
(10) Pub. No.: US 2025/0383364 A1
(43) Pub. Date: Dec. 18, 2025

(54) GENERATION OF MICROSCOPE IMAGES USING A SLIDE-SCANNER-MICROSCOPY SYSTEM

(71) Applicant: Carl Zeiss Microscopy GmbH, Jena (DE)

(72) Inventors: Markus NEUMANN, Jena (DE); Markus CAPPELLARO, München (DE); Moritz WIDMAIER, München (DE)

(73) Assignee: Carl Zeiss Microscopy GmbH, Jena (DE)

(21) Appl. No.: 19/235,797

(22) Filed: Jun. 12, 2025

(30) Foreign Application Priority Data
Jun. 13, 2024 (DE) 102024116601.0

(51) Int. Cl. G01N 35/00

(52) U.S. Cl. CPC G01N 35/00029; G01N 35/0099

(57) ABSTRACT

The disclosure relates to a slide-scanner microscopy system comprising a mount system configured to receive a plurality of holding frames that fix a respective microscopy slide, and comprising a robotic assembly configured to pick up a respective holding frame from the mount system and position it in such a way that the microscopy slide is arranged in an object plane of a microscope of the slide-scanner microscopy system. The microscope is configured to provide a microscopic imaging of the object plane onto an image plane. The slide-scanner microscopy system furthermore comprises a camera configured to capture individual images of the image plane, and a controller configured, in a predefined imaging mode of the slide-scanner microscopy system, to control the camera to capture a respective set of two or more individual images with a plurality of exposure parameter values for each of a plurality of positionings of a respective holding frame in the beam path and to compute each set of two or more individual images to form a high dynamic range microscope image.

### FIELD OF THE INVENTION

The present disclosure relates to the field of slide-scanner microscopy systems, in particular the generation of microscope images using automated slide-scanner microscopy systems.

### BACKGROUND OF THE INVENTION

Slide-scanner microscopy systems are able to scan complete microscopy slides and create high-resolution digital images for relatively large samples (e.g. in the cm range). This technology is widely used in medical diagnostics, research and training and can improve the efficiency and accuracy of the microscopic analysis.

Slide-scanner microscopy systems comprise various hardware components such as for example a microscope, a mount system for a plurality of microscopy slides and a camera. A slide-scanner microscopy system can furthermore have a robotic assembly as an automatic loading system in order to automatically scan microscopy slides one after another. In this way, for example up to 100 slides can be processed in one pass. For this purpose, the robotic assembly can position the slides successively for scanning in an object plane of the microscope, without a manual intervention being required. This automation considerably increases efficiency and is particularly useful in high throughput laboratories, where large amounts of samples need to be processed quickly and reliably.

The fields of use of slide-scanner microscopy systems are multifarious. In medical diagnostics, they make it possible to analyse samples on a computer screen, which facilitates a more accurate and faster diagnosis of diseases. Since the images are digital, they can be exchanged between experts at different locations, which results in a diagnosis being made faster and more precisely. In biomedical research, slide-scanner microscopy systems are used to examine cell and tissue structures in order to understand disease mechanisms and to develop new therapies. In pharmacology, too, they play an important part in assessing the efficacy and safety of new medicaments.

Slide-scanner microscopy systems can provide various contrast methods, for example fluorescence recordings and polarization recordings. Parameters of the slide-scanner microscopy system, such as for example exposure time, illumination brightness, gain and binning, can crucially influence the quality of the generated image data in the various contrast methods. By way of example, adaptation of the exposure time and illumination brightness in multi-channel recordings, especially in the field of fluorescence microscopy but also in transmitted-light methods such as polarization microscopy, for instance, can be crucial for the image quality.

Binning, for example in fluorescence microscopy, relates to a process in which adjacent pixels on a camera sensor are combined to form a larger “superpixel”. This can increase the sensitivity. Combining a plurality of pixels to form a single pixel amplifies the signal since the light signals of the individual pixels are added. This improves the camera's ability to detect weak signals, e.g. fluorescence signals, which is advantageous particularly for samples with little fluorescence or for very fast recordings. Furthermore, the image noise can be reduced. Since the signal is combined from a plurality of pixels, the noise that is normally associated with each individual pixel is also averaged. This results in overall a higher signal-to-noise ratio and thus in clearer images. Reducing the number of pixels to be processed enables the camera to record images faster and enables the image rate to be increased. Finally, the file size can be reduced. Fewer pixels means smaller image files, which facilitates data storage and processing.

In practice, binning means that, for example in the case of 2×2 binning, four adjacent pixels (2×2 pixels) are combined to form a superpixel. The resulting image then has only one quarter of the original resolution, but a higher light sensitivity and a better signal-to-noise ratio.

A further imaging parameter that affects the signal-to-noise ratio is the “gain”. Gain denotes the amplification of the electrical signal generated by the photodetectors of a camera for each pixel when light impinges on them. In connection with the camera of the slide-scanner microscopy system, this means that the gain adapts the degree of amplification of the original signal before the latter is digitized. The gain amplifies the electrical signal generated by the photodetectors. A higher gain results in a stronger amplification of the signal, as a result of which even weak light signals can be captured. While a higher gain amplifies the signal, the noise is also amplified in the process. This can influence the signal-to-noise ratio (SNR), such that noise becomes more dominant if gain is too high. An optimum gain balances signal amplification and noise in order to ensure a clear image quality. The brightness of the recorded image can be controlled by adapting the gain. In the case of weak fluorescence signals, the gain can be increased in order to make the image brighter and the details more visible. The gain also influences the dynamic range of the camera. An excessively high gain can result in bright regions of the image being overexposed and details thus being lost. An excessively low gain can result in weak signals being underrepresented and thus in a lack of sufficient contrast to represent details. It is important to set the gain so that the dynamic range of the camera is optimally utilized.

By way of example, a conventional camera can be operated with the standard parameters of gain 4 and binning 2×2 and can be used in this configuration for fluorescence microscopy. On account of the reduced readout noise, this setting results in a higher sensitivity of the sensor and thus in short exposure times. This setting is associated with a dynamic range that depends on the type of camera, for example. The dynamic range can be 1:2000, for example. Other cameras can have larger or smaller dynamic ranges. By virtue of the dynamic range associated with this setting, however, in existing techniques it is often necessary for a user to regularly check the set exposure times of the camera and adapt them to the sample in such a way that at every point of the sample, on the one hand, the minimum necessary exposure time affords a sufficient signal-to-noise ratio and, on the other hand, bright points present in the sample do not overmodulate the maximum saturation value of the camera. If appropriate, it is also necessary to adapt the brightness of the illumination source in order to keep the maximum exposure time of the cameras as short as possible and, on the other hand, to supply enough excitation energy for dark points. Both mean a considerable time expenditure and iteration effort for the user and reduce the attractiveness of the scanner as a routine device.

The procedure generally involves scanning relatively large sample regions (e.g. 1-2 cm²) which are combined from many individual camera images, each of which represents only a region of the sample. However, often the exposure time is set only on the basis of one individual camera image. It is therefore difficult for the user to find that region of the sample in which the signal is strongest in order then to determine an exposure time which simultaneously results in a sufficient contrast for less bright image structures and does not result in saturation of the sensor signal.

In a further example, a camera can be operated with the standard parameters of gain 1 and binning 1×1 and can be used in this way for polarization microscopy. The exposure time is normally determined for a specific setting angle of the crossed polarizers. Other angles can quickly give rise to a significantly higher signal brightness and thus saturation of the signal. At the same time, the signal quality of the dark regions can suffer from a low dynamic range, in a manner similar to that for fluorescence recordings. Here, too, it can therefore be difficult for the user to find that region of the sample in which the signal is strongest in order then to determine an exposure time which does not result in saturation of the sensor signal.

This problem can be exacerbated if the slide-scanner microscopy system has the ability to automatically scan many slides one after another, since different samples in different slides can result in other signal brightnesses. It is therefore difficult for the user to find the sample in which the signal is strongest in order then to determine an exposure time which does not result in saturation of the sensor signal. Furthermore, it is desirable to find an exposure time which is both below the sensor saturation threshold and represents the “darker” structures of the respective samples with sufficient contrast, specifically across a plurality of samples which vary in terms of signal brightness. This is because as soon as manual adaptations are required, the automated sequence of automatically scanning many slides one after another is interrupted.

### SUMMARY OF THE INVENTION

There is a need in the art to improve the imaging in a slide-scanner microscopy system, in particular in a slide-scanner microscopy system which automatically scans many slides one after another, taking into account the problems mentioned above.

The present disclosure relates to a slide-scanner microscopy system comprising a mount system, which can receive a plurality of holding frames that each fix one or a plurality of respective microscopy slides. The slide-scanner microscopy system furthermore comprises a microscope and a robotic assembly configured to pick up a respective holding frame from the mount system and position it in such a way that the microscopy slide or one of the microscopy slides is arranged in an object plane of the microscope. The microscope is configured to provide a microscopic imaging of the object plane onto an image plane. The slide-scanner microscopy system furthermore comprises a camera configured to capture individual images of the image plane, and a controller, for example a digital electronic controller. The controller is configured, in a predefined imaging mode of the slide-scanner microscopy system, to control the camera to capture a respective set of two or more individual images with a plurality of exposure parameter values for each of a plurality of positionings of a respective holding frame in the beam path and to compute each set of two or more individual images to form a high dynamic range microscope image.

The controller can for example compute each set of the two or more individual images by pixelwise weighted addition of pixels of the two or more individual images to form the high dynamic range microscope image.

By way of example, 25 holding frames can be provided in the mount system. Each holding frame can receive and fix in each case four microscopy slides, for example, such that a total of 100 microscopy slides can be accommodated in the mount system. With the aid of the robotic assembly, one of the holding frames can be removed from the mount system and positioned in such a way that one of the microscopy slides is arranged beneath an objective of the microscope in the object plane of the microscope. The microscopy slide can have a region for a sample to be examined by microscopy, which region is larger than the field of view of the microscope. In this case, the robotic assembly can be configured to move the microscopy slide in order to successively bring different regions of the sample to be examined by microscopy into the field of view of the microscope, such that the entire region of the sample to be examined by microscopy can be scanned.

The slide-scanner microscopy system can be operated in a so-called batch mode of operation, in which all the microscopy slides are moved from the mount system successively to the microscope and the corresponding samples in the respective microscopy slides are scanned.

It has been found that, in practical applications, the different samples often have greatly different brightnesses, even if the same imaging modality is used for all the samples, for example fluorescence microscopy or polarization microscopy. By virtue of the fact that the controller controls the camera in such a way that, in each position of the respective microscopy slide, a respective set of two or more individual images with different exposure parameter values is captured and the two or more individual images from a set are computed to form a microscope image, the dynamic range of this microscope image can be considerably greater than that of the individual images. This microscope image calculated in this way is therefore referred to herein as a high dynamic range microscope image.

Each set of individual images can comprise exactly two individual images, for example. A first of the two individual images can be captured for example with 1/5 of a reference exposure time and a gain of 1 and a second of the two individual images can be captured with 4/5 of the reference exposure time and a gain of 4. The reference exposure time can be 100 ms, for example, such that the first individual image is captured with an exposure time of 20 ms, and the second individual image with an exposure time of 80 ms. As a result, the total time expenditure for generating the microscope image does not increase, or increases only insignificantly. The time expenditure may increase somewhat since an image sensor in the camera, for example a CMOS sensor, now needs to be read twice. The first individual image can have a large dynamic range in bright regions of the sample or in bright samples and the second individual image can have a large dynamic range in dark regions of the sample or in dark samples.

As a result, the resulting dynamic range can be large enough that all regions of a sample, i.e. both very bright regions and very dark regions, can be captured with the same exposure parameter values. The resulting dynamic range can furthermore be large enough that all samples in all microscopy slides, i.e. both very bright samples and very dark samples, can be captured with the same exposure parameter values. The controller can therefore be configured to capture all sets of the two or more individual images with the same exposure parameter values for each positioning of two or more holding frames in the beam path of the microscope. As a result, it is possible, during a batch mode of operation, to avoid the need to change the exposure parameters within a scanning of one sample or in the course of the scanning of a plurality of samples.

The controller can be configured to control the camera to provide the high dynamic range microscope images in the predefined imaging mode with an increased bit depth by comparison with a further imaging mode. In the further imaging mode, for example, just one individual image is captured for each of a plurality of positionings of a respective holding frame in the beam path.

The exposure parameters assigned to the exposure parameter values can be for example the exposure time, the gain of the camera, the illuminance of an illumination module of the microscope, and/or binning. In particular, the exposure time and the gain of the camera are the exposure parameters which are associated with the illumination parameter values and which are varied during the recording of the two or more individual images of a set. By contrast, the illuminance of the illumination module and the binning can remain unchanged during the recording of the two or more individual images of a set.

For example, the controller can be configured to set the exposure parameter values, in particular exposure time and gain, as a function of one or a plurality of associated reference exposure parameter values obtained via a user interface. The reference exposure parameter values can be for example very conservative values, for example 10% to 20% of the modulation range such as is used for customary samples when the latter are recorded in the further imaging mode. Overload of the camera can be reliably prevented as a result.

In some examples, the camera is configured to output a trigger signal for an illumination module for each individual image. The illumination module can be configured to switch on an illumination of the object plane as a function of the trigger signal. The controller is configured to control the illumination module in the predefined imaging mode such that said module reacts only to every n-th trigger signal, wherein n is greater than one. Preferably, n is equal to the number of individual images per set. To put it another way, the illumination for the recording of the individual images of a set is switched on only once and remains switched on until the last individual image of the set has been recorded. This makes it possible to avoid unnecessary switching on and off of the illumination, as a result of which the lifetime of the illumination can be increased and it is possible to ensure a uniform illumination over the period of the recording of the individual images of the set. Moreover, the individual images can be captured more rapidly one after another, since latency as a result of the switching on and off of the illumination does not arise.

In some examples, the slide-scanner microscopy system furthermore comprises a screen having a display bit depth which is lower than a bit depth of the high dynamic range microscope images. The controller is configured to reproduce the high dynamic range microscope images on the screen on the basis of a transfer function between bit values of the high dynamic range microscope images and bit values of the screen. The transfer function can comprise a tone mapping, for example, in order to reduce the high contrast range of the high dynamic range microscope image in such a way that it can be represented on conventional output devices. It should be noted that this transfer function is different from a further transfer function used in the further imaging mode, for example a gamma correction.

The gamma correction can be applied in addition to the transfer function (e.g. tone mapping) in order to convert physically proportional (i.e. linear) brightness intensity into a non-linear brightness intensity suited to human sensation.

The transfer function (e.g. tone mapping) can be a global transfer function which is applied equally to all the pixels of the high dynamic range microscope images in order to determine bit values of the screen from the bit values of the high dynamic range microscope images. The controller can determine the global transfer function for example as a function of minimum values and maximum values of the bit values of the high dynamic range microscope images.

A further aspect relates to a method for a slide-scanner microscopy system. The slide-scanner microscopy system comprises a mount system configured to receive a plurality of holding frames that fix a respective microscopy slide. A holding frame can also fix a plurality of microscopy slides. The method involves picking up a holding frame from the mount system by means of a robotic assembly of the slide-scanner microscopy system, and positioning the picked-up holding frame in an object plane of a microscope of the slide-scanner microscopy system by means of the robotic assembly. A microscopic imaging of the object plane on an image plane is provided by means of the microscope. A camera of the slide-scanner microscopy system is controlled in a predefined imaging mode of the slide-scanner microscopy system to capture a respective set of two or more individual images of the image plane with a plurality of exposure parameter values for each of a plurality of positionings of a respective holding frame in the beam path and to compute each set of two or more individual images to form a high dynamic range microscope image.

The method can be carried out in particular using the slide-scanner microscopy system described above. The controller can have for example a corresponding program code in a memory of the controller, which program code, when executed by a processing unit of the controller, carries out the steps of the method. In this case, in accordance with the program code, the controller can control the robotic assembly, the microscope, the camera and further components of the slide-scanner microscopy system, such as for example an illumination source.

The method can be used in particular in conjunction with any kind of microscope which has a sufficient degree of automation in regard to the control of the camera and the automated movement of microscopy slides, for example a microscope having a motorized microscope stage having inserts for a plurality of microscopy slides which can be selectively moved into the object plane of a microscope. Examples of these may be light microscopes, in particular widefield microscopes.

A microscopy system comprises a microscope configured to provide a microscopic imaging of an object plane onto an image plane. The microscopy system also comprises a camera configured to capture a plurality of individual images of the image plane, for example for different positionings of a holding frame of a sample in the object plane. The microscopy system also comprises a controller configured, in a predefined imaging mode of the slide-scanner microscopy system, to control the camera to capture a respective set of two or more individual images with a plurality of exposure parameter values for each of a plurality of positionings of the holding frame in the beam path and to compute each set of two or more individual images to form a high dynamic range microscope image. The holding frame can be positioned in the object plane by means of a motorized actuator, for example. The controller can control the motorized actuator (for example an xy-stage) in order to displace the holding frame between the different positionings.

The features set out above and features described below can be used not only in the corresponding combinations explicitly set out, but also in further combinations or in isolation, without departing from the scope of protection of the present invention.

### BRIEF DESCRIPTION OF THE DRAWINGS

FIG. 1 schematically shows a slide-scanner microscopy system in accordance with one embodiment.

FIG. 2 shows method steps of a method in accordance with one embodiment.

FIG. 3 schematically shows the capture of a plurality of individual images and the dynamic ranges thereof in accordance with one embodiment.

FIG. 4 schematically shows dynamic ranges of individual images in conjunction with different exposure parameter values in accordance with one embodiment.

### DETAILED DESCRIPTION OF THE INVENTION

Some examples of the present disclosure generally provide a large number of circuits or other electrical devices. All references to the circuits and other electrical devices and the functionality provided by them are not intended to be restricted to encompassing only what is illustrated and described here. Even if specific designations can be assigned to the various circuits or other electrical devices, these designations are not intended to restrict the functional scope of the circuits and other electrical devices.

It goes without saying that the following description of embodiments should not be interpreted in a restrictive sense. The scope of the invention is not intended to be restricted by the embodiments described below or by the drawings, which are merely used to provide elucidation.

The drawings should be considered to be schematic illustrations and the elements depicted in the drawings are not necessarily illustrated as true to scale. Rather, the various elements are illustrated in such a way that their function and their general purpose become discernible to a person skilled in the art. Any connection or coupling between function blocks, devices, components or other physical or functional units which are illustrated in the drawings or described herein can also be realized by an indirect connection or coupling. Coupling between components can also be established by way of a wireless connection. Function blocks can be implemented in hardware, firmware, software or a combination thereof.

Some groups of elements, e.g. the plurality of holding frames or the plurality of microscopy slides, are identified by reference signs formed from a number and optionally a succeeding letter. Depending on the context, the reference sign may denote an individual element or all elements of the group. By way of example, each individual microscopy slide is designated by one of the reference signs 108A, 108B, 108C, or 108D, respectively. The totality of the plurality of microscopy slides is designated by the reference sign 108, i.e. without a succeeding letter. Identical reference signs in the various drawings refer to similar or identical components.

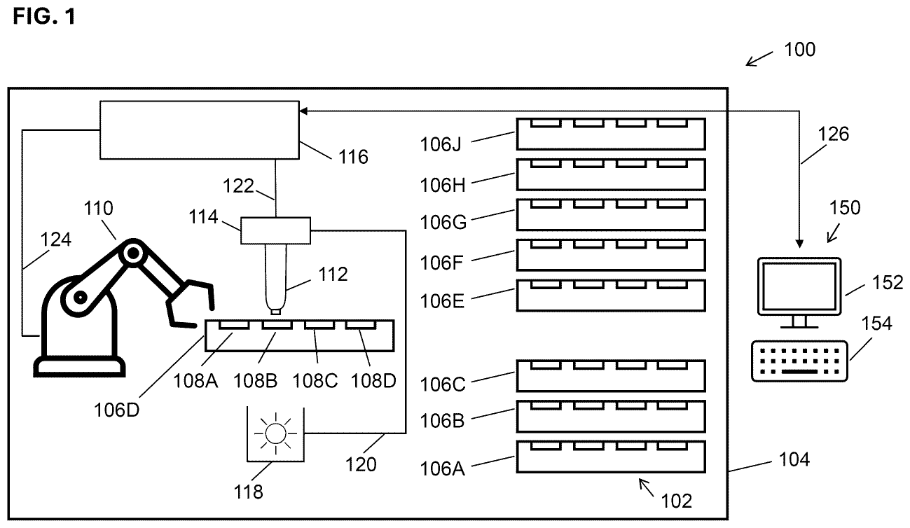

FIG. 1 schematically shows an exemplary slide-scanner microscopy system 100. The slide-scanner microscopy system 100 comprises a mount system 102 in a housing 104, a plurality of holding frames 106 being arranged in said mount system. The mount system 102 can be designed in the form of a shelf unit, for example, in which the holding frames 106 are stacked one above another. The mount system 102 can have a corresponding compartment for each of the holding frames 106, into which compartment a user can insert the respective holding frame 106. Other embodiments of the mount system 102 are likewise possible, for example a rotary turret in which the holding frames 106 are arranged next to one another in circular form. In other examples, the mount system 102 can hold the holding frames 106 on a conveyor belt. In the example shown in FIG. 1, the mount system 102 has space for nine holding frames 106A to 106J. In other examples, the mount system 102 can have space for 25 holding frames 106. One or a plurality of microscopy slides 108 can be arranged and held (fixed) in each holding frame 106. In the example in FIG. 1, four microscopy slides 108A to 108D can be fixed in each holding frame 106. In other examples, one, two, three or more than four microscopy slides 108 can be fixed in each holding frame 106. For example, the microscopy slides 108 can be inserted into cutouts provided in the holding frames 106.

A robotic assembly 110 is furthermore provided in the housing 104, said robotic assembly being able to remove one of the holding frames 106 from the holding system 102 and position it in a field of view of a microscope 112 in such a way that one of the microscopy slides 108 is situated in the field of view and an object plane of the microscope 112. In the example shown in FIG. 1, the microscopy slide 108B is situated in the field of view and in the object plane of the microscope 112.

The robotic assembly 110 is controlled by a controller 116 of the slide-scanner microscopy system 100 via a connection 124. The controller 116, as shown in FIG. 1, can be situated within the housing 104. In other examples, the controller 116 can also be situated outside the housing 104. The controller 116 can be for example a computer system having a main memory, a mass storage unit, a processing unit and input/output interfaces. A computer program can be loaded into the main memory in order to be executed by the processing unit in order that the processes described herein are carried out in an automated manner in the slide-scanner microscopy system 100.

The microscope 112 provides a microscopic imaging of the object plane on an image plane. A camera 114 is arranged in such a way that it captures individual images of the imaging of the object plane in the image plane. A microscopic imaging of a sample in the microscopy slide 108B is thus represented in the image plane and captured by the camera 114. The camera 114 is connected to the controller 116 via a further connection 122. Via the connection 122, the controller can trigger a recording of an individual image, for example. Furthermore, via the connection 122, exposure parameter values for the recording can be set and image information can be transferred from the camera 114 into the controller 116. The exposure parameter values can set for example an exposure time and a gain of the image sensor of the camera 114. The image information can be transferred as digital data, for example.

The camera 114 can be coupled via a connection 120 to an illumination module 118. For example, the connection 120 can comprise an electrical switching connection to trigger electronics in a control computer. The illumination module 118, for example an LED illumination, illuminates the object plane of the microscope. In the example shown in FIG. 1, the illumination module 118 is arranged below the microscopy slide 108B, such that a sample in the microscopy slide 108B is transilluminated. In other examples, the illumination module 118 can also be arranged on the same side as the microscope 112, for example by way of a sample in the microscopy slide 108B being illuminated from above through an objective of the microscope 112. Via the connection 120, the camera 114 can switch on and switch off the illumination module 118. The illumination of the sample is thus controlled by the camera 114. This enables fast and simple control and can prevent delays. In detail, the camera can receive a trigger signal for the recording of one or a plurality of individual images and, on the basis of this trigger signal, can switch on the illumination module 118 with a further trigger signal. For the purpose of controlling the illumination module 118 and the recording of one or a plurality of individual images, it is possible to use for example TTL (through the lens) control, i.e. a measurement or control through the objective of the microscope.

The slide-scanner microscopy system 100 can furthermore comprise a user interface 150, which is coupled to the controller 116 via a connection 126. The user interface 150 can comprise a screen 152 and a keyboard 154, for example. The user interface 150 can comprise further components, for example a mouse, a touch-sensitive surface, for example on the screen 152, a loudspeaker, a microphone, a camera and the like. The user interface 150, as shown in FIG. 1, can be provided outside the housing 104. In other examples, the user interface 150 can also be designed in a manner integrated into the housing 104.

The slide-scanner microscopy system 100 can operate in various imaging modes in order to scan samples in the plurality of microscopy slides 108 in an automated manner. The imaging modes can influence in particular the manner of operation of the camera 114.

The controller 116 can control the camera 114 for example to operate in a first imaging mode using exposure parameter values set by the controller. In the first imaging mode, on account of a trigger signal from the controller 116, the camera 114 records an individual image with the set exposure parameter values and returns this individual image to the controller 116. The scanning of the samples in the plurality of microscopy slides 108 takes place for example as follows in the first imaging mode. Under the control of the controller 116, the robotic assembly 110 successively moves in each case one of the microscopy slides 108 from one of the holding frames 106 into the field of view of the microscope 112. The robotic assembly 110 then moves the microscopy slide 108 in small steps beneath the objective of the microscope 112. During each step, the camera 114 is triggered and captures an individual image of a region of the sample. Each of these individual images is transferred to the controller 116, where the individual images are combined to form an overall image of the sample. This process is also referred to as “stitching”. Stitching ensures that the transitions between the individual images are seamless and that the overall image has a uniform exposure and sharpness.

Since the plurality of microscopy slides 108 may contain different samples and each sample may have a large sample region, e.g. 1-2 cm², the setting of the exposure parameter values may be difficult. Individual samples or sample regions may be overexposed or underexposed. Overexposed means for example that the sensor of the camera 114 is overloaded and, consequently, bright details of the sample are no longer distinguishable. Underexposed means for example that dark details of the sample supply too little light to sufficiently drive the sensor of the camera, and so these dark details of the sample are no longer distinguishable.

The sensor of the camera 114 can be a CMOS sensor, for example, which enables fast image recordings with high sensitivity and low noise. The dynamic range of the sensor can be 1:2000, for example. However, this may be too low for the large number of different samples and problem areas. An adaptation of the brightness of the illumination module and/or an adaptation of the exposure time and/or gain of the camera 114 may contribute to avoiding underexposure or overexposure, but are/is often undesirable, in particular within individual images of an individual sample, since this may lead to problems during stitching. Overall, an adaptation of the exposure parameter values may be undesirable in order to enable fast and simple scanning of many samples without additional user interventions. Moreover, images that have been recorded with identical exposure parameter values can be better compared with one another, as a result of which for example an analysis of identical objects in different samples can be improved across the different samples.

The slide-scanner microscopy system 100 can therefore have a second imaging mode. In the second imaging mode, the camera 114 divides the set exposure time between two or more individual recordings and computes the two or more individual recordings to form a high dynamic range microscope image. As a result, the control of the slide-scanner microscopy system 100 by the controller 116 can remain substantially unchanged.

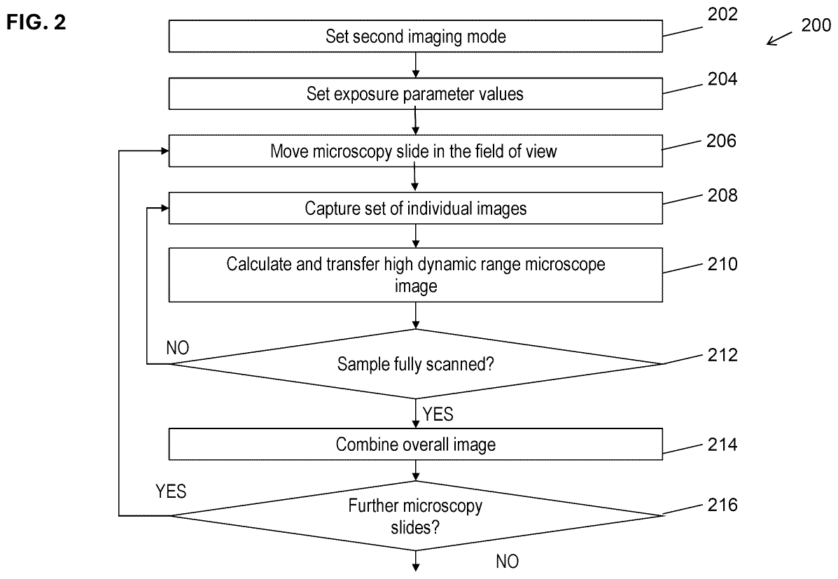

The manner of operation of the slide-scanner microscopy system 100 in the second imaging mode is described in detail below with reference to FIG. 2.

FIG. 2 shows method steps 202-216 of a method 200 which can be realized in the slide-scanner microscopy system 100, in particular in the controller 116 and in the camera 112.

In step 202, the controller 116 sets the second imaging mode in the camera 114, for example by means of a communication via the connection 122. For the camera, the setting of the second imaging mode means that, on account of a triggering, the camera records a set of two or more individual images. For reasons of simplification, it is assumed below that a set consists of two individual images. However, the principle is equally applicable to a set of three, four or more individual images. The configuration of the second imaging mode can specify for example how many individual images the camera 114 has to record on account of a triggering.

In step 204, the controller 116 sets exposure parameter values for the camera 114 which are to be used for the recording of a set of the two individual images. By way of example, reference exposure parameter values can specify a reference exposure time and reference gain such as can be used in the first imaging mode, for example. On the basis of these reference exposure parameter values, it is possible to set the exposure parameter values for a first individual image of the set of two individual images and for a second individual image of the set of two individual images, for example automatically in the camera 114. For example, it is possible to use 1/5 of the reference exposure time as exposure time for the first individual image in conjunction with the reference gain. For the second individual image, it is possible to use 4/5 of the reference exposure time as exposure time in conjunction with four times the reference gain. If, for example, the reference exposure time is 100 ms and the reference gain is 1, an exposure time of 20 ms and a gain of 1 can be set for the first individual image and an exposure time of 80 ms and a gain of 4 can be set for the second individual image.

In step 206, a first sample is moved into the field of view of the microscope 112. For this purpose, the robotic assembly 110 can remove a holding frame 106 from the mount system 102 and position it in such a way that the microscopy slide 108 containing the first sample is situated in the object plane of the microscope 112.

The sample is then systematically scanned. The camera 114 receives a trigger signal from the controller 116. On account of the trigger signal, the camera 114 switches on the illumination module 118. Then, in step 208, a set of individual images is captured, for example, as described above, the first individual image and the second individual image with the corresponding exposure times and gains. For example, the first individual image is captured with an exposure time of 20 ms and a gain of 1, and the second individual image with an exposure time of 80 ms and a gain of 4. Afterwards, the camera 114 can switch off the illumination module 118. In step 210, a high dynamic range microscope image is calculated from the first individual image and the second individual image. For this purpose, for example, weighted addition of the corresponding pixels of the first individual image and the second individual image can be effected. This calculation, too, can be carried out in the camera 114.

In other examples, the controller 116 can provide a corresponding trigger signal for the camera 114 for each individual image. In this case, the camera 114 can utilize for example only every n-th trigger signal, for example only every second trigger signal, in order that the two individual images can be correspondingly rapidly recorded directly in succession. The calculation of the high dynamic range microscope image can be carried out in the controller 116 if the two individual images are transferred from the camera 114 to the controller 116.

During the computation of the individual images to form a high dynamic range microscope image, the overexposed and underexposed pixels can be ignored, for example. The pixels with intermediate brightness can be weighted as follows, for example. Assuming that a higher sensitivity in the response behaviour of the image sensor of the camera 114 results in a more reliable brightness value, the derivative of the camera curve can be used as a weighting function. In order to avoid the large gradients of the camera curve in the case of very low and high brightness values, a function falling to the extrema can be used for weighting purposes, which function preferably deals with pixels with a medium brightness value. Assuming that higher values are less susceptible to noise, the derivative of the camera curve can be multiplied by the pixel value. This product can furthermore be multiplied by the function falling to the extrema in order to avoid equivocal intensity values near the extrema. Further methods for computing the individual images to form a high dynamic range microscope image can alternatively be used.

The high dynamic range microscope image calculated in this way is transferred from the camera 114 to the controller 116.

Step 212 involves checking whether the sample has been completely scanned. If the sample has not yet been completely scanned, the sample is moved a small step with the aid of the robotic assembly 110, such that another region of the sample is in the field of view of the microscope 112 and this other region is in turn scanned with two individual images in step 208. Steps 208-212 are repeated often enough until all regions of the sample have been scanned.

Once all regions of the sample have been scanned, in step 214 the controller 116 calculates the overall image of the sample from the plurality of high dynamic range microscope images which have been calculated and transferred for the plurality of regions of the sample.

Step 216 involves checking whether there are further samples in further microscopy slides 108 which are to be examined. If there are further microscopy slides 108 with further samples to be examined, the robotic assembly 110 is controlled in step 206 to arrange a next microscopy slide 108 in the field of view of the microscope 112. If appropriate, this necessitates the robotic assembly 110 moving the current holding frame 106 back into the mount system 102 and removing another holding frame 106 from the mount system 102. Method steps 206-216 are repeated often enough until all microscopy slides 108 with samples to be examined have been scanned.

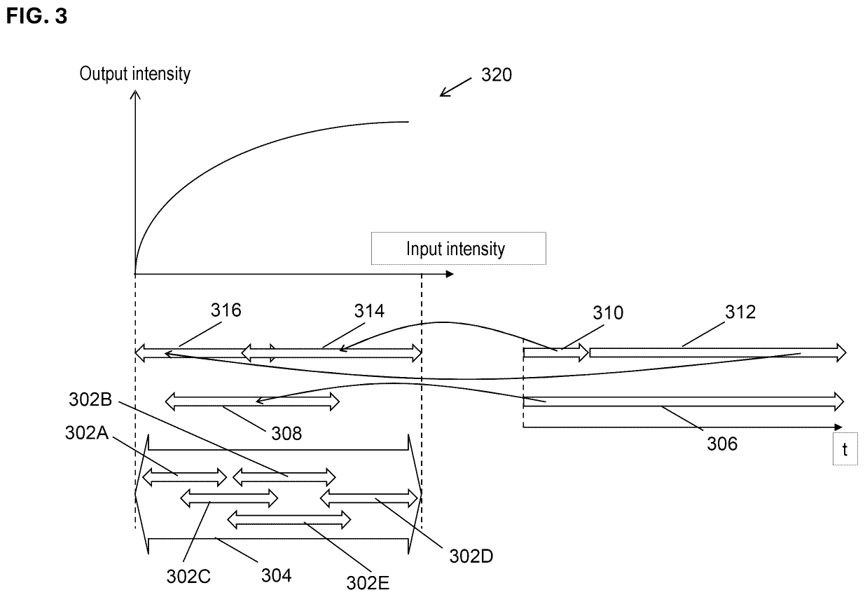

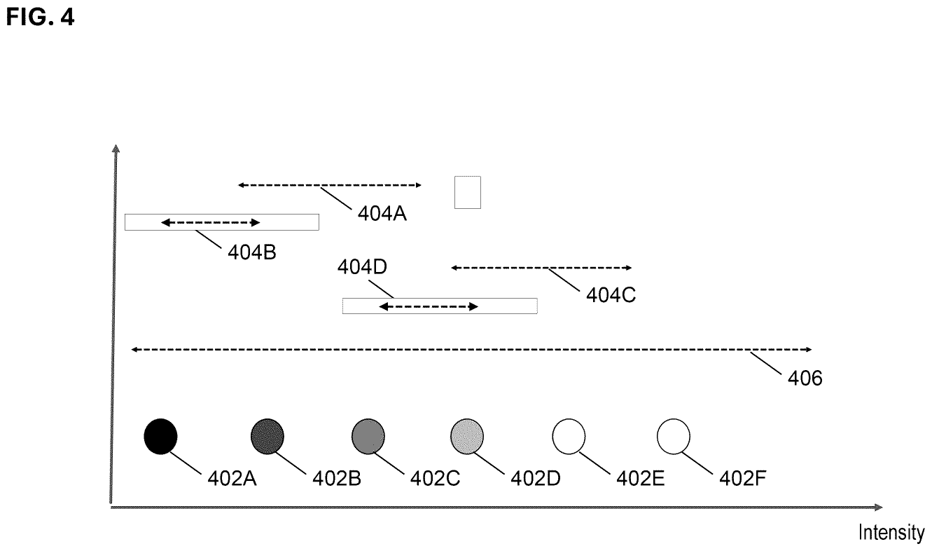

The above-described choice of the exposure parameter values is just one example, and the exposure time and gain for the individual images can also be stipulated differently and also independently of the reference exposure parameter values mentioned above. The above-described exposure parameter values achieve a considerable dynamic range, however, as will be clarified below with reference to FIG. 3 and FIG. 4.

Intensity ranges of different samples or of different sample regions can vary, as illustrated for example by the double-headed arrows 302 in FIG. 3. One sample can have for example an intensity range at low intensities, such as for example in the region 302A, whereas another sample can have an intensity range at high intensities, such as for example in the region 302D. Overall, a dynamic range that covers the entire intensity range 304 is therefore required.

This dynamic range can be greater than a dynamic range that can be covered by a customary camera sensor in conjunction with a specific exposure time, gain and illumination. With a use of a customary sensor in the camera 114 in the first imaging mode with an exposure time of for example 100 ms (illustrated by the reference sign 306) and a gain of 1, only the dynamic range 308 can be covered, for example, such that the sample with the sample region 302A is at least partly underexposed and the sample with the sample region 302D is at least partly overexposed.

With a use of the same sensor in the second imaging mode with an exposure time of for example 20 ms (illustrated by the reference sign 310) and a gain of 1 for the first individual image and with an exposure time of for example 80 ms (illustrated by the reference sign 312) and a gain of 4 for the second individual image, a first dynamic range 314 and respectively a second dynamic range 316 can be covered, which together cover the entire required dynamic range 304.

The overall image created in this way can have a dynamic range that is greater than the dynamic range of an output unit of the user interface 150, for example greater than the dynamic range of the screen 152. In order nevertheless to be able to represent the overall image on the screen 152, an intensity adaptation with a gamma correction, for example, can be carried out, as is illustrated in the diagram 320 in FIG. 3. Each input intensity value of the overall image is assigned a corresponding output intensity value that can be represented on the screen 152. The dynamic range of the output intensity values is less than the dynamic range of the input intensity values, but covers the entire dynamic range. The screen characteristic curve can be automatically adapted to minimum values and maximum values of the input intensity values and a suitable gamma correction can be automatically set in order to output even dark images with sufficient contrast on the screen.

FIG. 4 elucidates by way of example what sample intensities can be covered by what dynamic ranges. The sample intensities are illustrated by way of example as six greyscale levels 402A to 402F. Dynamic ranges of microscope images that were captured in the first imaging mode are identified by the reference signs 404. The dynamic range of microscope images that were captured in the second imaging mode is identified by the reference sign 406.

With an exposure time of 100 ms in conjunction with a gain of 1, it is possible for example to cover the dynamic range 404C, i.e. sample intensities in the range of the greyscale levels 402D and 402E. With an exposure time of 100 ms in conjunction with a gain of 4, it is possible for example to cover the dynamic range 404D, i.e. sample intensities in the range of the greyscale levels 402C and 402D. The gain can cause the dynamic range to decrease, as illustrated by the shorter arrow 404D compared with the arrow 404C. With an exposure time of 300 ms in conjunction with a gain of 1, it is possible for example to cover the dynamic range 404A, i.e. sample intensities in the range of the greyscale levels 402B and 402C. With an exposure time of 300 ms in conjunction with a gain of 4, it is possible for example to cover the dynamic range 404B, i.e. sample intensities in the range of the greyscale levels 402A and 402B. However, none of the dynamic ranges 404 can cover all intensities 402.

Contrast and brightness may increase, in principle, with longer exposure times. If the gain is increased, the exposure time can be reduced and the same brightness can be obtained, depending on the setting, but then at the expense of the smaller dynamic range.

A dynamic range of microscope images that were captured with the second imaging mode is identified by the reference sign 406. This dynamic range encompasses all sample intensities in the range of the greyscale levels 402A-402F. High contrast and high brightness can be attained over a large dynamic range in the second imaging mode.

In summary, an imaging mode, the second imaging mode mentioned above, for high dynamic range microscope images is provided in which the set exposure time is divided between two individual recordings. The first image is recorded for example with 1/5 of the set exposure time with a gain of 1 and the second image is recorded for example with 4/5 of the set exposure time and with a gain of 4. The two images are computed (by weighted addition) with one another such that an image with a significantly increased dynamic range arises as a result. The advantage of this method is that the total duration of the recording is lengthened only to an insignificant degree and at the same time there arises an image with low noise (optimized signal-to-noise ratio) in image regions with low intensity and without the risk of sensor saturation in bright image regions. With this imaging mode, the exposure time can be set without losses of image quality in such a way that the image histogram is aligned on the left, i.e. the available, recordable contrast range is considerably extended to brighter image regions. The camera thus has enough dynamic range reserve for even brighter signals. In comparison with the first imaging mode with a gain of 4, for example, the resulting increase in dynamic range is more than 15-fold. This is achieved by the setting of the camera being changed to the second imaging mode, in which the camera independently records two or more individual images with predefined exposure parameter values after a simple triggering. Corresponding standard templates for scanning profiles in the second imaging mode can be provided in the user interface and edited in a corresponding profile editor. The high dynamic range microscope image generated can have a larger bit depth, for example 16 bits instead of 14 bits. The abovementioned reference value for the exposure time can be set in such a way that no saturation of the camera occurs for most/customary samples.

The contrast range provided as a result for the camera is large enough that, for example, at an arbitrary point of a large-area fluorescence sample with locally very different fluorescence intensities (e.g. from the field of application of pathology) with a low intensity range, the exposure time can be set to a conservative modulation range of approximately 10-20%, for example, and brighter regions at other points in the specimen can therefore still be imaged safely and without overmodulation. At the same time in conjunction with a very good signal-to-noise ratio (SNR) the darker points can likewise be reproduced in a highly detailed manner and without superimposition of noise.

By means of two or more sequential recordings with shared exposure time and the intensity-correct superimposition of these individual images, a microscope image with an extended contrast range can be created without the recording being slowed down. The normally time-consuming, iterative setting of an appropriate exposure time can thus be avoided in many typical sample situations.

It goes without saying that the features of the embodiments and aspects of the invention described above can be combined with one another. In particular, the features can be used not only in the combinations described but also in other combinations or on their own, without departing from the scope of the invention.

By way of example, techniques in association with slide-scanner microscopy systems have been described above. However, the techniques described herein can also be used in association with other microscopy systems. By way of example, the techniques described herein can be used in particular in association with microscopy systems which have a motorized microscope stage for stitching large-area microscope images. The problem that the brightness of the examined sample can in part vary significantly occurs in that context as well.

What is claimed is:

1. A slide-scanner microscopy system, comprising:
a mount system configured to receive a plurality of holding frames that fix a respective microscopy slide,
a robotic assembly configured to pick up a respective holding frame from the mount system and position it in such a way that the microscopy slide is arranged in an object plane of a microscope of the slide-scanner microscopy system,
the microscope configured to provide a microscopic imaging of the object plane onto an image plane,
a camera configured to capture individual images of the image plane, and
a controller configured, in a predefined imaging mode of the slide-scanner microscopy system, to control the camera to capture a respective set of two or more individual images with a plurality of exposure parameter values for each of a plurality of positionings of a respective holding frame in the beam path and to compute each set of two or more individual images to form a high dynamic range microscope image.

2. The slide-scanner microscopy system according to claim 1, wherein the controller is configured to capture all sets of the two or more individual images with the same exposure parameter values for each positioning of two or more holding frames in the beam path.

3. The slide-scanner microscopy system according to claim 1, wherein one or a plurality of exposure parameters associated with the exposure parameter values are selected from the group comprising: exposure time and gain.

4. The slide-scanner microscopy system according to claim 1, wherein the controller is configured to set the exposure parameter values as a function of one or a plurality of associated reference exposure parameter values obtained via a user interface.

5. The slide-scanner microscopy system according to claim 1,
wherein the camera is configured to output a trigger signal for each individual image,
wherein an illumination module of the microscope is configured to switch on an illumination of the object plane as a function of the trigger signal, and
wherein the controller is configured to control the illumination module in the predefined imaging mode to react only to every n-th trigger signal, wherein n is greater than one.

6. The slide-scanner microscopy system according to claim 5, wherein n is equal to the number of individual images per set.

7. The slide-scanner microscopy system according to claim 1, wherein the controller is configured to control the camera to provide the high dynamic range microscope images in the predefined imaging mode with an increased bit depth by comparison with a further imaging mode.

8. The slide-scanner microscopy system according to claim 1, furthermore comprising:
a screen having a display bit depth which is lower than a bit depth of the high dynamic range microscope images,
wherein the controller is configured to reproduce the high dynamic range microscope images on the screen on the basis of a transfer function between bit values of the high dynamic range microscope images and bit values of the screen, and
wherein the transfer function is different from a further transfer function used in a further imaging mode.

9. The slide-scanner microscopy system according to claim 8, wherein the transfer function is a global transfer function which is applied equally to all the pixels of the high dynamic range microscope images in order to determine bit values of the screen from the bit values of the high dynamic range microscope images.

10. The slide-scanner microscopy system according to claim 9, wherein the controller is configured to determine the global transfer function as a function of minimum values and maximum values of the bit values of the high dynamic range microscope images.

11. The slide-scanner microscopy system according to claim 1, wherein the controller is configured to compute each set of the two or more individual images by pixelwise weighted addition of pixels of the two or more individual images to form the high dynamic range microscope image.

12. The slide-scanner microscopy system according to claim 1, wherein each set of two or more individual images comprises exactly two individual images, wherein a first of the two individual images is captured with 1/5 of a reference exposure time and a reference gain and a second of the two individual images is captured with 4/5 of a reference exposure time and four times the reference gain.

13. A method for a slide-scanner microscopy system, wherein the slide-scanner microscopy system comprises a mount system configured to receive a plurality of holding frames that fix a respective microscopy slide, wherein the method comprises:
picking up a holding frame from the mount system by means of a robotic assembly of the slide-scanner microscopy system,
positioning the picked-up holding frame in an object plane of a microscope of the slide-scanner microscopy system by means of the robotic assembly,
providing a microscopic imaging of the object plane on an image plane by means of the microscope,
controlling a camera of the slide-scanner microscopy system in a predefined imaging mode of the slide-scanner microscopy system to capture a respective set of two or more individual images of the image plane with a plurality of exposure parameter values for each of a plurality of positionings of a respective holding frame in the beam path and to compute each set of two or more individual images to form a high dynamic range microscope image.
